(19) United States
(12) Patent Application Publication
(10) Pub. No.: US 2016/0239917 A1
(43) Pub. Date: Aug. 18, 2016

(54) Processing Performance Risk Using a Performance Risk Navigator

(71) Applicant: Xerox Corporation, Norwalk, CT (US)

(72) Inventors: Theodore A. Goldman, Potomac, MD (US); Stuart Schulman, South Orange, NJ (US); D. Ryan Miller, Los Angeles, CA (US); Dean Aloise, McMurray, PA (US); Scot Martin, Brooklyn, NY (US); Steven K. Petersen, Los Angeles, CA (US); David W. Zalewski, Pittsburgh, PA (US); Caroline Kaplonski, Nutley, NJ (US)

(21) Appl. No.: 14/853,406

(22) Filed: Sep. 14, 2015

Related U.S. Application Data
(60) Provisional application No. 62/115,530, filed on Feb. 12, 2015.

(51) Int. Cl. G06Q 40/06

(52) U.S. Cl. CPC G06Q 40/06

(57) ABSTRACT

A performance risk analysis method including receiving, at a device implemented in hardware, user information and a performance goal, generating a portfolio based on the user information and the performance goal, performing a stochastic simulation on the portfolio to generate a performance metric, and outputting the performance metric. An apparatus comprising a receiver configured to receive user information and a performance goal, a memory, and a processor operably coupled to the receiver and the memory, and configured to generate a portfolio based on the user information and the performance goal, perform a stochastic simulation on the portfolio to generate a performance metric, and output the performance metric.

### CROSS-REFERENCE TO RELATED APPLICATIONS

The present application claims benefit of U.S. Provisional Patent Application No. 62/115,530 filed Feb. 12, 2015 by Theodore A. Goldman, et al., and entitled, “Pension Risk Navigator,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Determining the amount of risk and performance associated with a user and user-defined goals is challenging. Existing tools are limited in their ability to aggregate user information for determining the amount of risk and performance associated with the user and the user-defined goals. For example, many financial tools are not web enabled and cannot be easily integrated to work with other financial tools. As a result, financial calculations are performed and analyzed independently using a plurality of financial tools.

### SUMMARY

In one embodiment, the disclosure includes a performance risk analysis method comprising receiving, at a device implemented in hardware, user information and a performance goal, generating, at the device, a portfolio based on the user information and the performance goal, performing, at the device, a stochastic simulation on the portfolio to generate a performance metric, and outputting, from the device, the performance metric.

In another embodiment, the disclosure includes an apparatus comprising a receiver configured to receive user information and a performance goal, a memory, and a processor operably coupled to the receiver and the memory, and configured to generate a portfolio based on the user information and the performance goal, perform a stochastic simulation on the portfolio to generate a performance metric, and output the performance metric.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a system for implementing a performance risk navigator.

FIG. 2 is a schematic diagram of another embodiment of a system for implementing a performance risk navigator.

FIG. 3 is a schematic diagram of an embodiment of a network element for implementing a performance risk navigator.

FIG. 4 is a flowchart of an embodiment of a performance risk analysis using a performance risk navigator.

FIG. 5 is an illustration of an embodiment of a chart your course module user interface.

FIG. 6 is an illustration of an embodiment of a scenario builder module user interface.

FIG. 7 is an illustration of another embodiment of a scenario builder module user interface.

FIG. 8 is an illustration of an embodiment of a dashboard module user interface.

FIG. 9 is an illustration of another embodiment of a dashboard module user interface.

FIG. 10 is an illustration of an embodiment of a take action module user interface.

FIG. 11 is a flowchart of an embodiment of a performance risk analysis method.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various embodiments for implementing a performance risk analyses using a performance risk navigator. In an embodiment, a performance risk navigator may be employed to perform a performance risk analysis for a pension plan by obtaining user information and performance goals (e.g., financial information and pension goals), performing model simulations using the provided user information and performance goals, and determining performance metrics (e.g., likelihood of success) for meeting the performance goals for the pension plan based on the model simulation results. Further, a performance risk navigator is employed to use user information (e.g., historical or on-going financial information for a pension plan) to determine a performance risk factor (e.g., a pension risk factor) that indicates an amount of risk associated with the pension plan in accordance with the user information. As an example, a performance risk navigator may be configured to allow a user (e.g., a pension plan sponsor or client) to access a detailed analysis of a pension plan's funded position and progress towards achieving funding and investing goals. Further, a performance risk navigator may be configured as a pension risk navigator to establish outcome-based goals for pension plans and to evaluate the impact of potential mitigating actions for reducing the pension plan's risk. For example, mitigating actions for a pension plan include, but are not limited to, closing a pension plan to new participants, freezing accruals, purchasing lump sums, purchasing annuities, modifying asset allocations, and implementing a de-risking glide path. The performance risk navigator allows users to view (e.g., in about real-time) the potential effects on the likelihood of achieving performance goals using stochastic forecasting methods. A user can make better informed decisions on matters that impact their employees and shareholders using the performance risk navigator.

Using a performance risk navigator allows a user to use a single user interface to obtain inputs from a variety of sources such as remote databases and a local user. Existing solutions may require the user to use multiple user interfaces to obtain user inputs from a variety of sources. The user interface is adaptable and accommodates different combinations of inputs. For example, the performance risk navigator may be configured to operate using various combinations of inputs where the number of inputs may vary. The performance risk navigator is robust and supports a broad range of inputs. The performance risk navigator is configurable to generate and process one or more portfolios at a time based on the inputs. For example, multiple portfolios may be generated and processed at once. The performance risk navigator may be configured to simultaneously generate and output the performance metric for multiple portfolios. The performance risk navigator is also configurable to generate action items that are uniquely associated with the one or more portfolios based on the inputs and the performance metrics. Many of these features cannot be performed without the computer system described here.

A performance risk navigator is configured to obtain inputs such as user information and performance goals from a plurality of sources. For example, a performance risk navigator may obtain inputs for a pension plan from a user (e.g., a pension sponsor or client), an actuary's work product, trustee asset information, or a database. The performance risk navigator is configured to use the inputs to generate several performance metrics for measuring and/or displaying performance (e.g., a pension plan's health). For example, performance metrics for a pension plan may comprise liabilities (e.g., projected benefit obligation (PBO), accumulated benefit obligation (ABO), and funding target liability) computed daily, projected asset levels, projected required contribution levels, projected pension benefit guaranty corporation (PBGC) premiums (e.g., per head or variable), projected funded ratios, and/or any other suitable performance metric as would be appreciated by one of ordinary skill in the art upon viewing this disclosure.

As an example, performance metrics for a pension plan may be reported stochastically with a probability distribution computed each year up to ten years. A user (e.g., a pension plan sponsor) can articulate pension goals with the performance risk navigator, for example, by establishing performance metrics and one or more performance goals. Multiple performance goals may also be concatenated. The performance risk navigator is configured to compute a likelihood of success (e.g., a probability score) for the performance goals based on outcomes of prepopulated stochastic paths using a model simulator. A user may compare resulting probability scores with other probability scores based on alternative scenarios to make informed decisions.

As another example, a user (e.g., a client) can use the performance risk navigator to perform a lump sum versus annuity analysis. The user may want to reduce their long-term risk by offering lump sums or purchasing annuities for plan participants. The performance risk navigator is populated with financial inputs and projection models for each option, for example by a consultant. The performance risk navigator will process the financial inputs and models to generate one or more performance metrics for the client. The client can use the performance metrics to determine the likelihood of success for their goals based on each scenario and to determine a course of action in accordance with the performance metrics.

Further, the performance risk navigator is configured to compute a performance risk factor. A performance risk factor for a pension plan is a value that reflects a pension plan's funded ratio, hedge ratio, and equity exposure. A user can see the impact on their performance risk factor of various decisions such as lengthening their bond portfolio, making additional contributions, or reducing equity exposure.

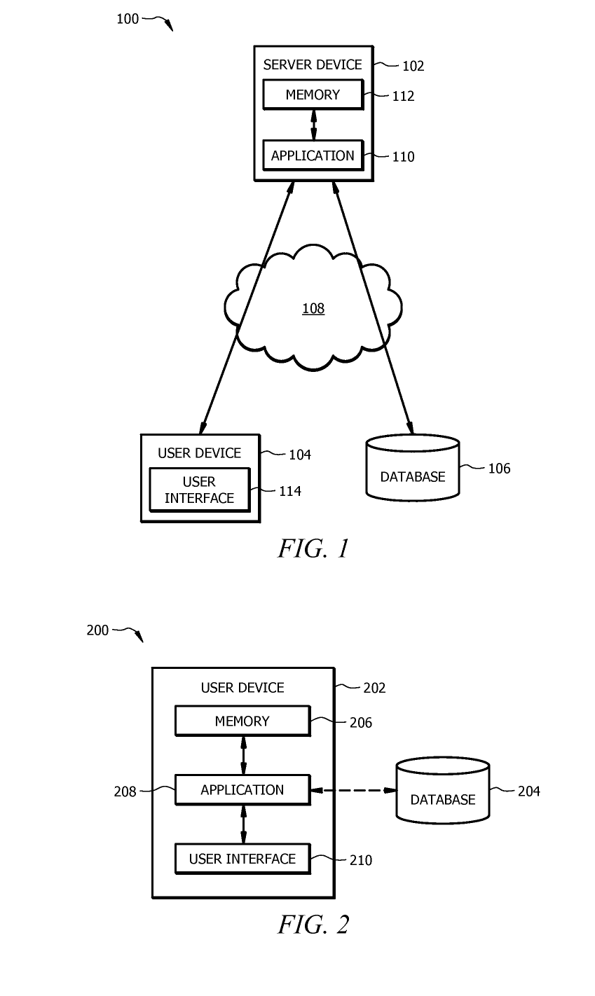

FIG. 1 is a schematic diagram of an embodiment of a system 100 for implementing a performance risk navigator. System 100 comprises a server device 102, a user device 104, and a database 106. System 100 may be configured as shown or in any other suitable configuration as would be appreciated by one of ordinary skill in the art upon viewing this disclosure. Server device 102 is a network node configured to support the transportation of data traffic through a network 108. Examples of network 108 include, but are not limited to, Internet Protocol (IP) networks, virtual network, and local area networks. Server device 102 may comprise a computer, a server, a switch, a router, or any other suitable networking device for communicating data packets or supporting the transportation of data packets as would be appreciated by one of ordinary skill in the art upon viewing this disclosure. Server device 102 is operably coupled to and in data communication with user device 104 and database 106. Examples of connections between server device 102, user device 104, and database 106 include, but are not limited to, links, tunnels, an internet connection, wireless network connections, and wired network connections. Links discussed herein may be physical links, such as electrical links, optical links, and/or logical links (e.g., virtual links). A tunnel may include, but is not limited to, an IP security (IPsec) tunnel or a generic routing encapsulation (GRE) tunnel.

In an embodiment, the server device 102 has a processor (not shown), a memory 112 and application 110. Alternatively, the application 110 is stored in the user device 104. The memory 112 may be a volatile or non-volatile read-only memory (ROM), random-access memory (RAM), ternary content-addressable memory (TCAM), static random-access memory (SRAM), or any other suitable type of memory as would be appreciated by one of ordinary skill in the art upon viewing this disclosure. Memory 112 is configured to store user information and/or instructions for executing application 110. The application 110 is configured to execute the performance risk navigator. The application 110 may be an application or an application suite configured to receive and to transmit data between the server device 102, the user device 104, and the database 106. For example, the application 110 may be configured to interact with the user device 104 via a user interface 114 on the user device 104. The application 110 is also configured to store and retrieve data, such as, user information, from memory 112 and/or database 106. Examples of the user device 104 include, but are not limited to, network computers, tablet computers, desktop computers, mobile telephones, servers, or any other suitable networking device as would be appreciate by one of ordinary skill in the art upon viewing this disclosure. The user device 104 has a user interface 114 that is configured to interact with the application 110 in the server device 102 to exchange (e.g., transmit and receive) data with application 110. The user interface 114 may be realized as a virtual element, a physical network element, or embedded in a physical element. The user device 104 may be configured to have or to access one or more other applications, an operating system (OS), or a hypervisor. Database 106 is an external memory that may be stored in another device. The database 106 may be located in about the same geographical location or in a different geographical location as the service device 102 or the user device 104. Database 106 is configured to store user information for application 110. Database 106 may be prepopulated by the user with user information or may be populated by a third-party with user information.

FIG. 2 is a schematic diagram of another embodiment of a system 200 for implementing a performance risk navigator. System 200 comprises a user device 202 and a database 204. System 200 may be configured as shown or in any other suitable configuration as would be appreciated by one of ordinary skill in the art upon viewing this disclosure. User device 202 is operably coupled to and in data communication with database 204. Examples of connections between user device 202 and database 204 include, but are not limited to, links, tunnels, an internet connection, wireless network connections, and wired network connections. Links discussed herein may be physical links, such as electrical links, optical links, and/or logical links (e.g., virtual links). The user device comprises a processor (not shown), a memory 206, user interface 210, and application 208. The application 208 is configured to execute a performance risk navigator. The memory 206 may be a volatile or non-volatile ROM, RAM, TCAM, SRAM, or any other suitable type of memory as would be appreciated by one of ordinary skill in the art upon viewing this disclosure. Memory 206 is configured to store user information and/or instructions for executing application 110. The application 208 may be an application or an application suite configured to interact with the memory 206, the user interface 210, and the database 204. The user interface 210 is configured to interact with application 208 to exchange (e.g., transmit and receive) data with application 208. The user interface 210 may be realized as a virtual element, a physical network element, or embedded in a physical element. The user device 202 may be configured to have or to access one or more other applications, an OS, or a hypervisor. Examples of the user device 202 include, but are not limited to, network computers, tablet computers, desktop computers, mobile telephones, servers, or any other suitable networking device as would be appreciate by one of ordinary skill in the art upon viewing this disclosure. Database 204 is an external memory that may be stored in another device. The database 204 may be located in about the same geographical location or in a different geographical location as the user device 202. Database 204 is configured to store user information for application 110. Database 204 may be prepopulated by the user with user information or may be populated by a third-party with user information. In an embodiment, the database 204 may be omitted.

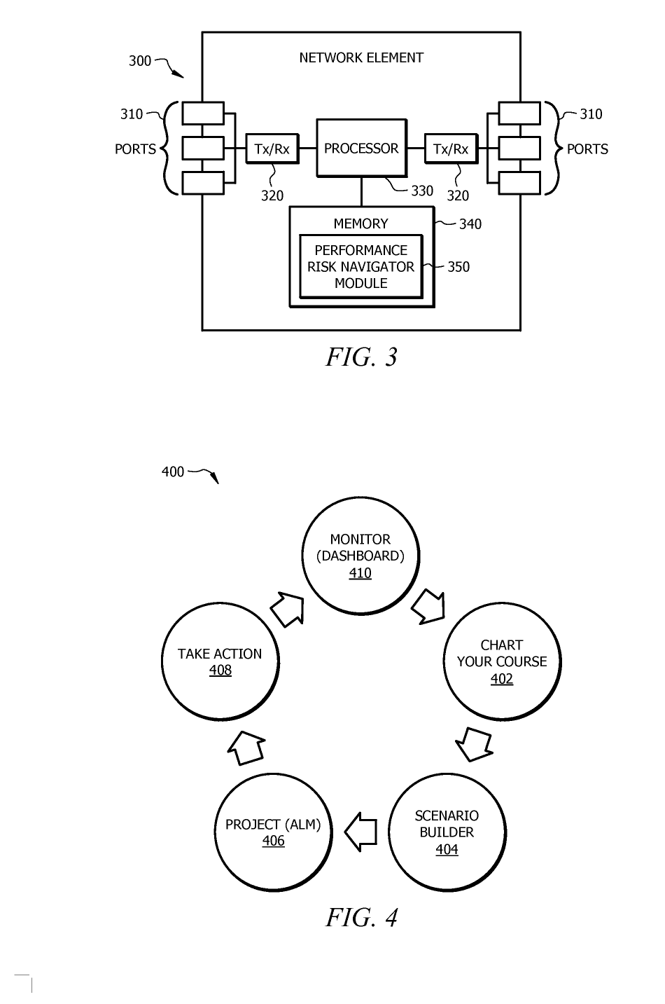

FIG. 3 is a schematic diagram of an embodiment of a network element 300. The network element 300 may be suitable for implementing the disclosed embodiments. Network element 300 may be any device such as a computer, a laptop, a mobile phone, a smartphone, a tablet, a web-enabled computing device, a client, a server, or any other suitable device as would be appreciated by one of ordinary skill in the art upon viewing this disclosure. For example, network element 300 may be in and/or integrated within a server device 102, a user device 104, or database 106 in FIG. 1 or user device 202 or database 204 in FIG. 2. Network element 300 includes ports 310, transceiver units (Tx/Rx) 320, a processor 330, and a memory 340 comprising a performance risk navigator module 350. Ports 310 are coupled to Tx/Rx 320, which may be transmitters, receivers, or combinations thereof. The Tx/Rx 320 may transmit and receive data via the ports 310. Processor 330 is configured to process data. Memory 340 is configured to store data and instructions for implementing embodiments described herein. The network element 300 may also include electrical-to-optical (EO) components and optical-to-electrical (OE) components coupled to the ports 310 and Tx/Rx 320 for receiving and transmitting electrical signals and optical signals.

The processor 330 may be implemented by hardware and software. The processor 330 may be implemented as one or more central processing unit (CPU) chips, logic units, cores (e.g., as a multi-core processor), field-programmable gate arrays (FPGAs), application specific integrated circuits (ASICs), and digital signal processors (DSPs). The processor 330 is in communication with the ports 310, Tx/Rx 320, and memory 340.

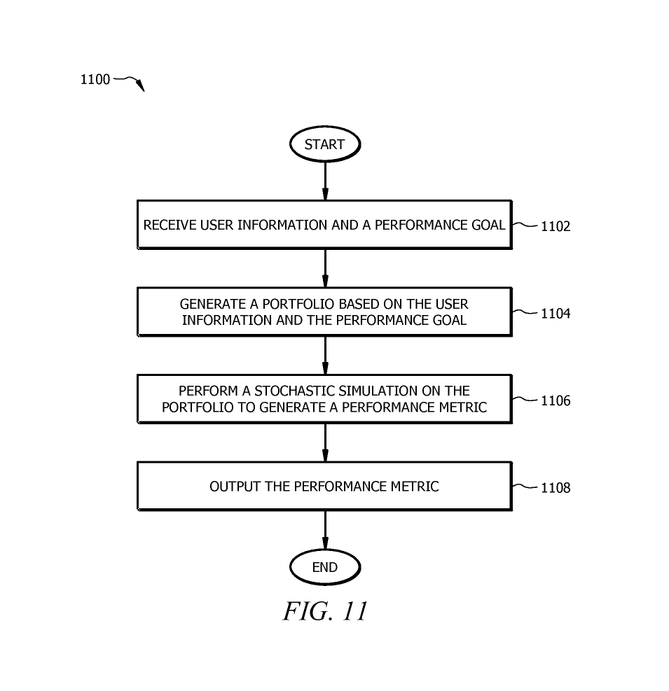

The memory 340 includes one or more of disks, tape drives, and solid-state drives and may be used as an over-flow data storage device, to store programs when such programs are selected for execution, and to store instructions and data that are read during program execution. The memory 340 may be a volatile or non-volatile ROM, RAM, TCAM, SRAM, or any other suitable type of memory as would be appreciated by one of ordinary skill in the art upon viewing this disclosure. The performance risk navigator module 350 is implemented by processor 330 to execute the instructions for implementing various embodiments for carrying out the various example embodiments described herein. The performance risk navigator module 350 performs at least part of the performance risk analysis 400 in FIG. 4 or method 1100 in FIG. 11. In an embodiment, the performance risk navigator module 350 may employed for a pension plan to obtain financial information, pension goals, and/or portfolios, to perform model simulations using the provided financial information and pension goals, and to determine performance metrics (e.g., likelihood of success) for meeting the pension goals based on the model simulation results. Further, a performance risk navigator module 350 is employed to determine a pension risk factor for the pension plan that indicates an amount of risk associated with the pension plan based on the provided financial information. The inclusion of the performance risk navigator module 350 provides an improvement to the functionality of network element 300. The performance risk navigator module 350 also effects a transformation of network element 300 to a different state. Alternatively, the performance risk navigator module 350 is implemented as instructions stored in the processor 330.

FIG. 4 is a flowchart of an embodiment of a performance risk analysis 400 using a performance risk navigator (e.g., performance risk navigator module 350 in FIG. 3). Performance risk navigator 400 may be implemented in an application such as application 110 in a server device 102 in FIG. 1 or application 208 in a user device 202 in FIG. 2. Performance risk analysis 400 comprises a chart your course module 402, a scenario builder module 404, a project module 406, a take action module 408, and a dashboard module 410. The pension risk analysis 400 may be configured as shown or in any other suitable manner. The performance risk analysis 400 may implemented to perform various analysis operations. For example, analysis operations for a pension plan may include, but are not limited to, assessing a current funded position of a pension plan, quantifying risks associated with a pension plan (e.g., interest rate risk, equity risk, and longevity risk), measuring an impact of daily changes in interest rates and assets returns on a pension plan's funded status, measuring an impact on a probabilistic basis of changes in asset allocation and/or implementation of liability driven investing glide paths, measuring an impact of settlor decisions (e.g., mitigating actions), and generating projections based on a pension plan's current position and simulation models.

Chart your course module 402 is configured to obtain user inputs such as user information (e.g., financial information), performance goals (e.g., pension goals), and performance goal parameters (e.g., pension goal parameters) and to display one or more performance metrics that are generated in accordance with the obtained user inputs. Chart your course module 402 is configured to display a likelihood of success that is generated in accordance with the user defined performance goals. Scenario builder module 404 is configured to create custom portfolio scenarios using the obtained user inputs. The custom portfolio scenarios can be used to generate portfolio projections using an asset/liability modeler (ALM) such as project module 406. An ALM may generate portfolio projections based on risks due to mismatches between assets and liabilities for the portfolio. For example, the ALM may be configured to maximize assets to meet complex liabilities that are associated with the portfolio. Any suitable ALM may be employed as would be appreciated by one of ordinary skill in the art upon viewing this disclosure. Project module 406 is an asset/liability modeler configured to obtain portfolio scenarios from scenario builder module 404 and to perform stochastic simulations (e.g., Monte Carlo simulations) on the portfolio scenarios. For example, the project module 406 for a pension plan may perform stochastic simulations of pension liabilities and assets performance on the portfolios for a pension plan. Project module 406 is configured to use a plurality of inputs (e.g., project liability cash flows, current assets, liabilities, discount rates, and projection assumptions) and to output performance metrics (e.g., performance metric graphs) in accordance with the simulation results from the stochastic simulations. For example, the project module 406 for a pension plan may output performance metrics for projected liabilities, contributions, plan expense, and assets. Project module 406 may also be configured to store performance metrics into a memory or to output a file, a graph, a table, a summary, a report, or any other suitable output as would be appreciated by one of ordinary skill in the art. Further, project module 406 is configured to implement one or more models (e.g., assets/liability models from a financial consultant) that can be used in conjunction with portfolios and/or performance goals to generate performance metrics. In an embodiment, project module 406 may be implemented using ALM express. Take action module 408 is configured to display one or more actions or action items associated with user plans (e.g., a pension plan) and portfolio scenarios. Actions are generated in accordance with the simulation results from project module 406. Dashboard module 410 is configured to display one or more performance metrics associated with a user plan and portfolio scenario that are generated in accordance with the results from project module 406. For example, the performance metrics for a pension plan may comprise a likelihood of success, a pension risk factor, and a funded status for the pension plan.

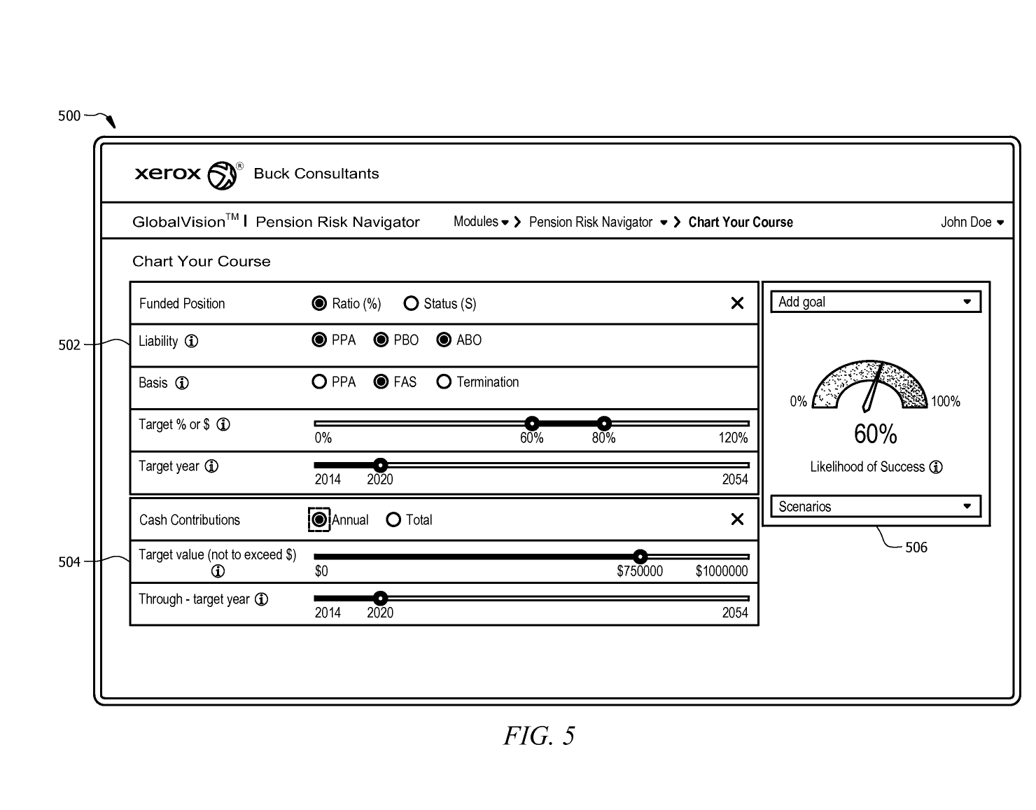

FIG. 5 is an illustration of an embodiment of a chart your course module user interface 500. Chart your course module user interface 500 may be implemented for a chart your course module (e.g., chart your course module 402 described in FIG. 4) of a performance risk analysis (e.g., performance risk analysis 400 described in FIG. 4) in a performance risk navigator (e.g., performance risk navigator module 350 in FIG. 3) for a pension plan. Chart your course module user interface 500 may be implemented in a user interface for an application such as user interface 114 for the server device 102 in FIG. 1 or user interface 210 for the user device 202 in FIG. 2. Chart your course module user interface 500 comprises a plurality of performance goal parameter modules 502 and 504 and a performance metric module 506. Chart your course module user interface 500 may be configured as shown or in any other suitable configuration. Performance goal parameter modules 502 and 504 for a pension plan each comprise one or more pension goal settings that are associated with pension performance goals (e.g., cash contribution goals, funded position goals, PBGC premium goals, and pension expense goals). Pension performance goals may comprise any suitable number of performance goals and/or combination of performance goals. For example, a cash contribution goal can be set for next year and another cash contribution goal can cover the total amount contributed over the next ten years. performance goal parameter settings for a pension plan may include, but are not limited to, a funded ratio setting (e.g., assets divided by liabilities), a funded status setting (e.g., assets minus liabilities), a funding liability on a Pension Protection Act (PPA) basis setting, an accounting liability on a PBO setting, an accounting liabilities on an ABO setting, a PPA basis setting, a financial accounting standards basis setting, a termination basis setting, a target funded ratio setting, a target funded status setting, a target end year setting, a target value not to exceed setting, other funded position settings, and other cash contribution settings. Performance metric module 506 is configured to display one or more performance metrics. Performance metric module 506 may comprise any suitable combination or configuration of performance metrics for a performance goal. For example, the performance metric module 506 comprises a likelihood of success indicator that measures or indicates performance goals against a particular projection scenario. The percentage represents the number of successful trials and is determined from the simulation results of the project module for portfolios defined by a scenario builder module (e.g., scenario builder module 404 described in FIG. 4) and performance goals defined by a chart your course module (e.g., chart your course module 402 described in FIG. 4).

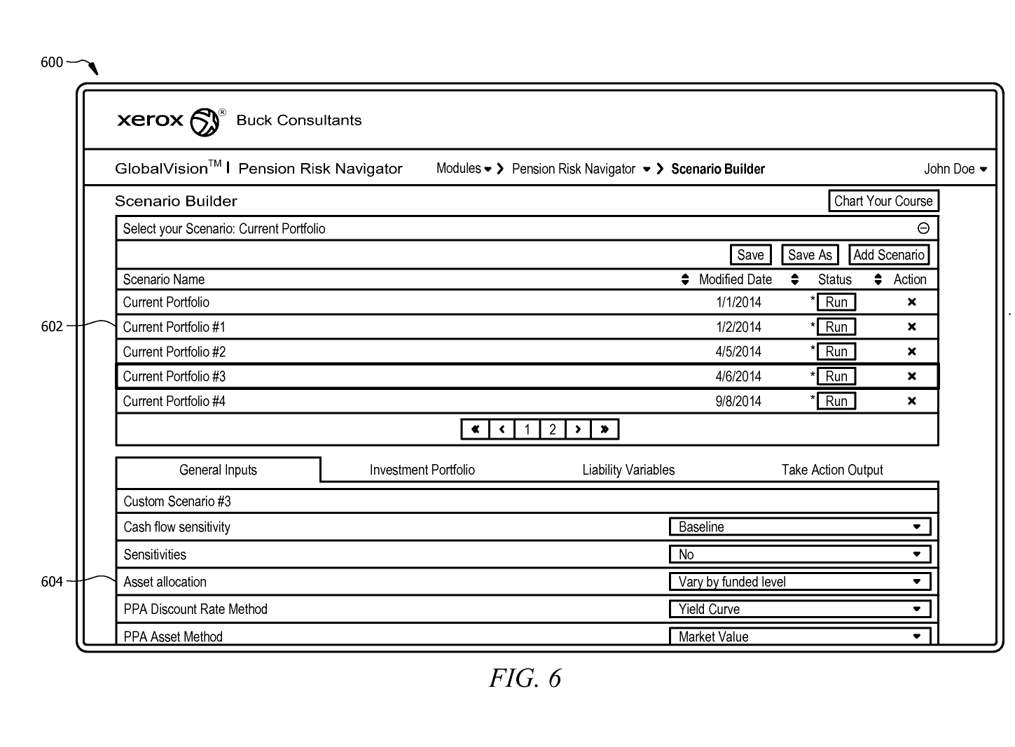

FIG. 6 is an illustration of an embodiment of a scenario builder module user interface 600. Scenario builder module user interface 600 may be implemented for a scenario builder module (e.g., scenario builder module 404 described in FIG. 4) of a performance risk analysis (e.g., performance risk analysis 400 described in FIG. 4) in a performance risk navigator (e.g., performance risk navigator module 350 in FIG. 3) for a pension plan. Scenario builder module user interface 600 comprises a portfolio organizer module 602 and a portfolio parameters module 604. Scenario builder module user interface 600 may be implemented in a user interface for an application such as user interface 114 for the server device 102 in FIG. 1 or user interface 210 for the user device 202 in FIG. 2. Scenario builder module user interface 600 may be configured as shown or in any other suitable configuration. Portfolio organizer module 602 is configured to establish and organize user-defined portfolios that are associated with various user plans. For example, a user may generate and store a plurality of custom portfolios with different portfolio parameter settings. Portfolio parameters module 604 is configured to portfolio parameter settings that are associated with a portfolio. Portfolio parameter settings for a pension plan may include, but are not limited to, cash flow sensitivity settings (e.g., cash flow streams and cash flow information), sensitivity settings (e.g., high sensitivity and low sensitivity for cash flow streams), asset allocation settings, constant asset allocation settings (e.g., constant investment allocation), vary by funded asset allocation settings (e.g., adjusts asset allocation as funded status changes), vary by year change asset allocation settings (e.g., adjusts asset allocation each year), PPA discount rate method settings (e.g., measure liabilities using a full yield curve, PPA unadjusted segment rates, and PPA adjusted segment rates), PPA asset method setting (e.g., market value of assets, actuary value of assets, and smoothed actuary value of assets), investment portfolio settings, liability variables settings, and take action output settings.

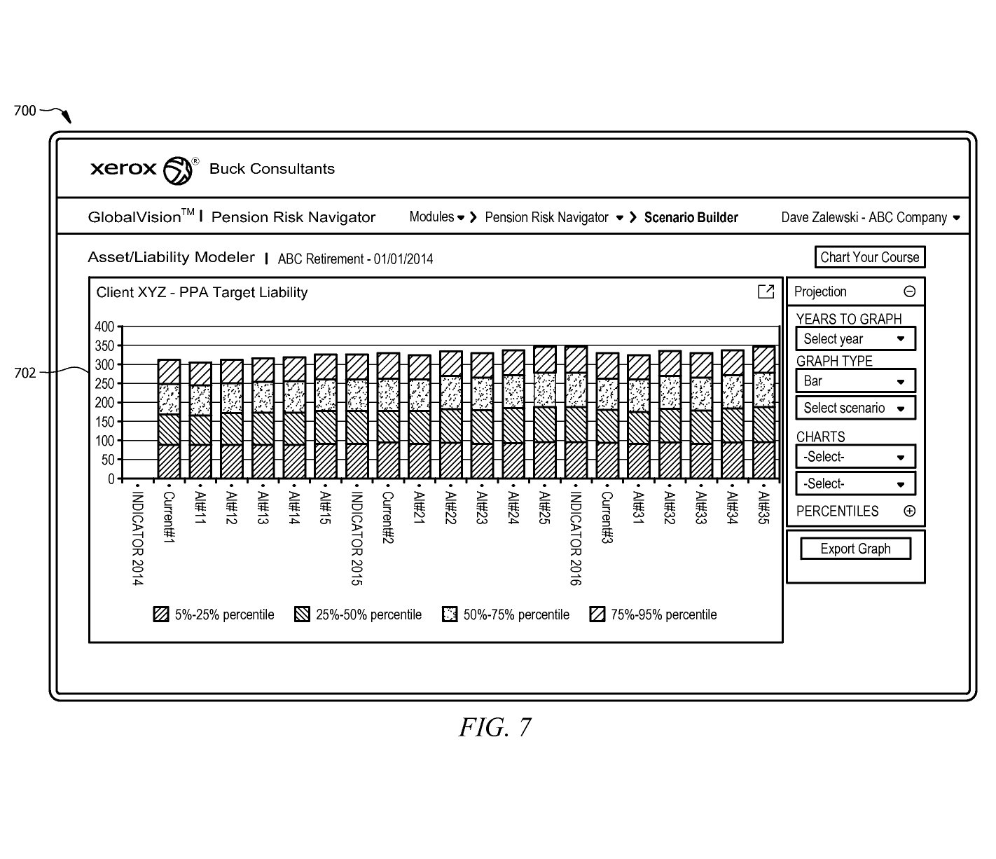

FIG. 7 is an illustration of another embodiment of a scenario builder module user interface 700. Scenario module user interface 700 may be implemented for a scenario builder module (e.g., scenario builder module 404 described in FIG. 4) of a performance risk analysis (e.g., performance risk analysis 400 described in FIG. 4) in a performance risk navigator (e.g., performance risk navigator module 350 in FIG. 3) for a pension plan. Scenario builder module user interface 700 may be implemented in a user interface for an application such as user interface 114 for the server device 102 in FIG. 1 or user interface 210 for the user device 202 in FIG. 2. Scenario builder module user interface 700 may be configured as shown or in any other suitable configuration. Scenario builder module user interface 700 comprises one or more performance metric modules 702. Performance metric module 702 is configured to display one or more performance metrics for user-defined portfolios that are associated with various pension plans. Performance metric module 702 may comprise any suitable combination or configuration of performance metrics for a portfolio and/or a performance goal. For example, performance metric module 702 for a pension plan comprises a PPA target liability graph.

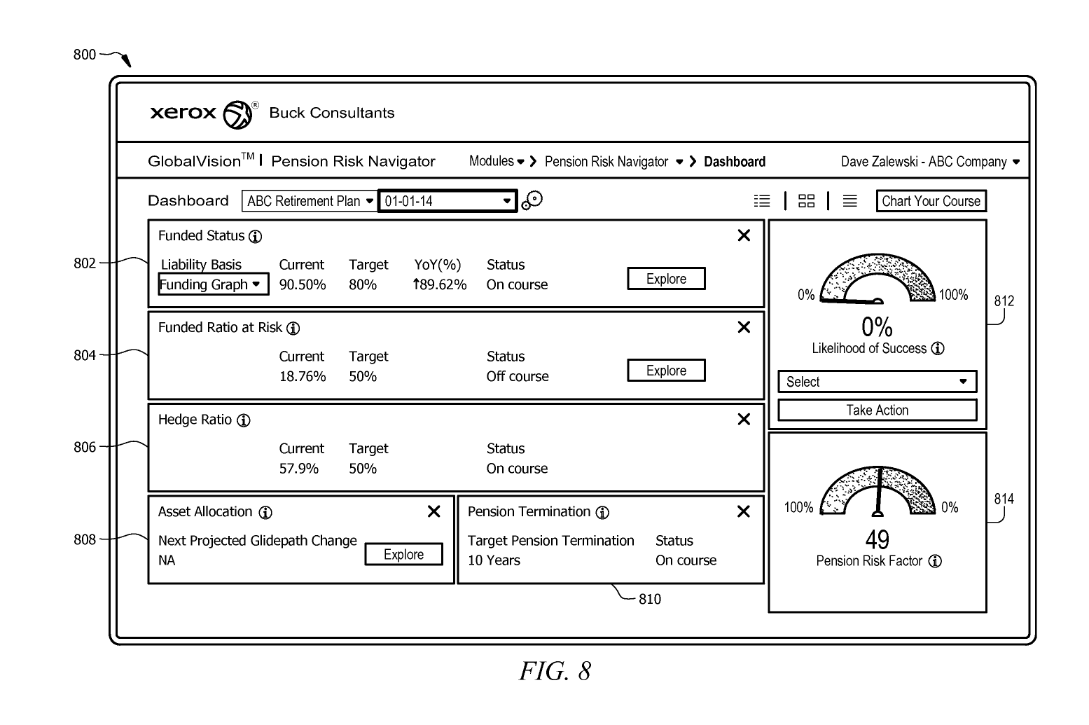

FIG. 8 is an illustration of an embodiment of a dashboard module user interface 800. Dashboard module user interface 800 may be implemented for a dashboard module (e.g., dashboard module 410 described in FIG. 4) of a performance risk analysis (e.g., performance risk analysis 400 described in FIG. 4) in a performance risk navigator (e.g., performance risk navigator module 350 in FIG. 3). Dashboard module user interface 800 comprises a plurality of performance metric modules 802-814. Dashboard module user interface 800 may be implemented in a user interface for an application such as user interface 114 for the server device 102 in FIG. 1 or user interface 210 for the user device 202 in FIG. 2. Dashboard module user interface 800 may be configured as shown or in any other suitable configuration. Performance metric modules 802-814 are configured to display one or more performance metrics for user-defined portfolios that are associated with various user plans. Performance metric modules 802-814 are generated in accordance with the results from a project module (e.g., project module 406 described in FIG. 4). Performance metric modules 802-814 may comprise any suitable combination or configuration of performance metrics for a performance goal. For example, a performance metric module 802 for a pension plan comprises funded status performance metrics such as a liability basis, a current funded value, a target funded value, amount funded change value (e.g., percentage of funding change from beginning of year), and a status indicator. Performance metric module 804 for the pension plan comprises funded ratio at risk performance metrics such as a current funded ratio at risk value, a target funded ratio at risk value, and a status indicator. Performance metric module 806 for the pension plan comprises hedge ratio performance metrics such as a current hedge ratio value, a target hedge ratio value, and a status indicator. Performance metric module 808 for the pension plan comprises asset allocation performance metrics such as a next projected glide path change indicator. Performance metric module 810 for the pension plan comprises pension termination performance metrics such as a target pension termination year and status indicator. Performance metric module 812 for the pension plan comprises a likelihood of success indicator. The likelihood of success can be determined as described in FIG. 5. Performance metric module 814 for the pension plan comprises a pension risk factor indicator. A pension risk factor indicator indicates the amount of pension risk associated with a pension plan by examining the amount of investment risk and the current funded position. The pension risk factor may be calculated using historical financial information for portfolios and pension goals and/or financial information from external sources. The pension risk factor may be determined as follows:

$$Pension Risk Factor = 1 - [ ( P B O Funded Ratio ) \times ( 1 - ( \frac{Risky Asset Exposure}{5} ) ) \times \sqrt{Hedge Ratio} ] ,$$

where PBO Funded Ratio is the market value of assets divided by PBO liabilities, Risky Asset Exposure is the percentage of total invested in equities, hedge funds, and commodities, and Hedge Ratio is the estimated portion of liabilities that are protected from interest rate risk (e.g., not exposed to the risk of interest rate fluctuations). The pension risk factor may be stored into a memory or output to a file, a graph, a table, a summary, a report, or any other suitable output as would be appreciated by one of ordinary skill in the art. For example, a summary may be a text-based report that indicates user information, a funded status, a funded ratio risk, a hedge ratio, an asset allocation, a pension termination date, a likelihood of success, and/or the pension risk factor.

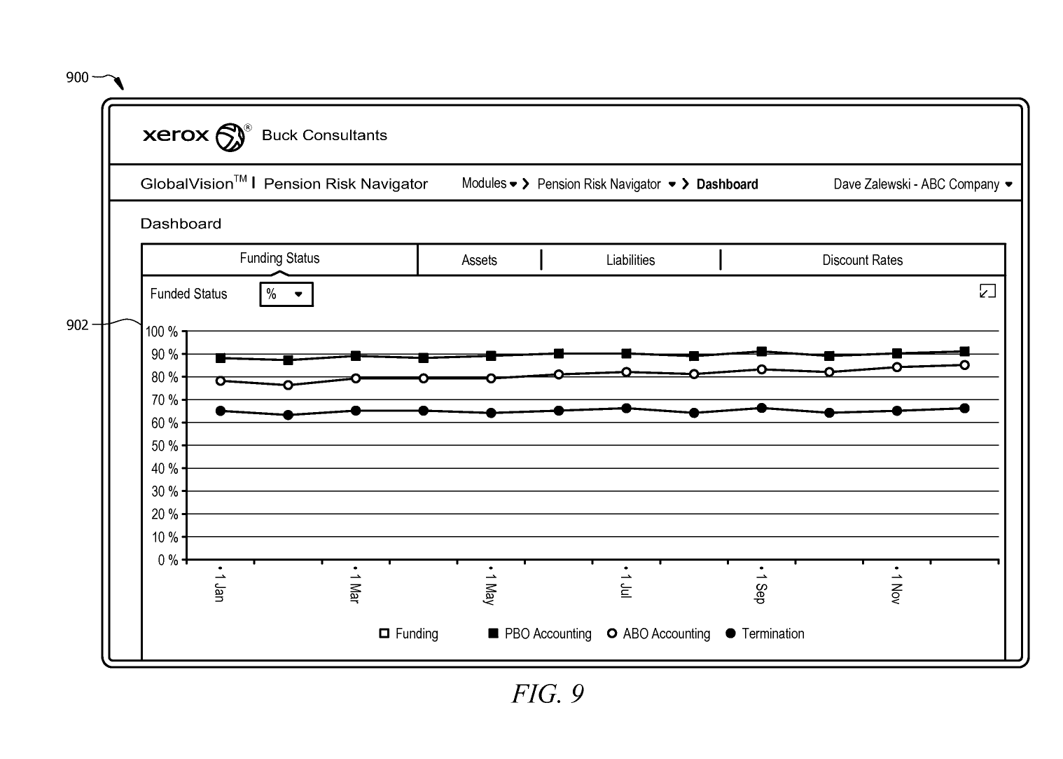

FIG. 9 is an illustration of another embodiment of a dashboard module user interface 900. Dashboard module user interface 900 may be implemented for a dashboard module (e.g., dashboard module 410 described in FIG. 4) of a performance risk analysis (e.g., performance risk analysis 400 described in FIG. 4) in a performance risk navigator (e.g., performance risk navigator module 350 in FIG. 3). Dashboard module user interface 900 may be implemented in a user interface for an application such as user interface 114 for the server device 102 in FIG. 1 or user interface 210 for the user device 202 in FIG. 2. Dashboard module user interface 900 comprises a performance metric module 902. Performance metric module 902 is configured similarly to performance metric modules 802-814 described in FIG. 8. Performance metric module 902 for a pension plan comprises a graph of funding percentages, PBO accounting percentages, ABO accounting percentages, and termination percentages over time. Performance metric module 902 may also include, but is not limited to, performance metric graphs or displays for assets, liabilities, and discount rates. Dashboard module user interface 900 may be configured as shown or in any other suitable configuration.

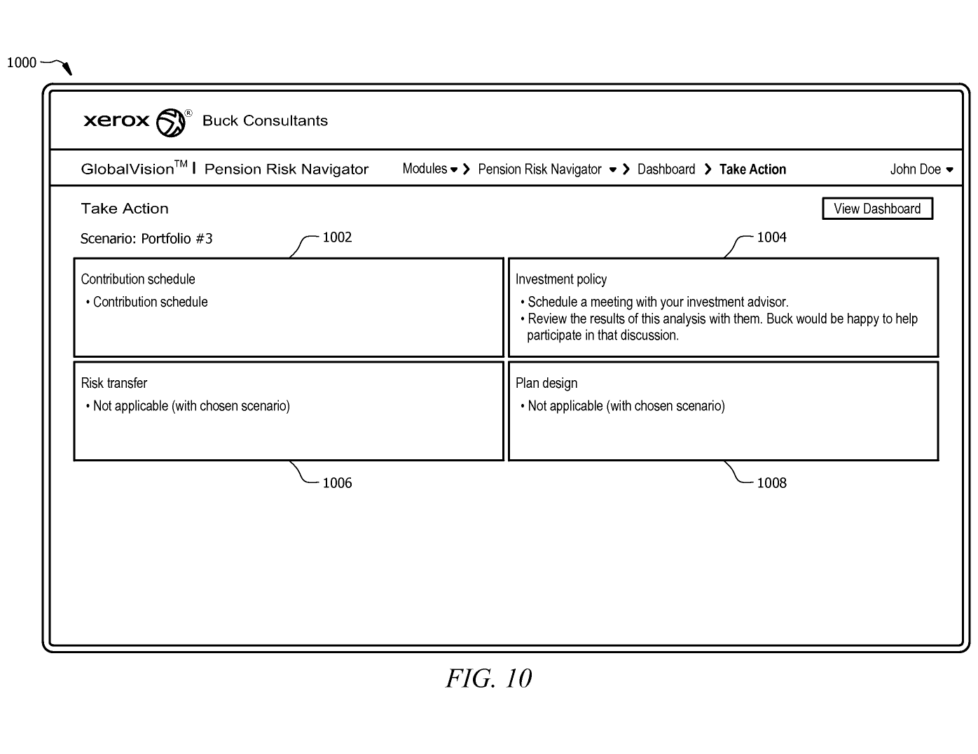

FIG. 10 is an illustration of an embodiment of a take action module user interface 1000. Take action module user interface 1000 may be implemented for a take action module (e.g., take action module 408 described in FIG. 4) of a performance risk analysis (e.g., performance risk analysis 400 described in FIG. 4) in a performance risk navigator (e.g., performance risk navigator module 350 in FIG. 3). Take action module user interface 1000 may be implemented in a user interface for an application such as user interface 114 for the server device 102 in FIG. 1 or user interface 210 for the user device 202 in FIG. 2. Take action module user interface 1000 comprises action modules 1002-1008 for user-defined portfolios that are associated with various user plans. Take action module user interface 1000 may be configured as shown or in any other suitable configuration. Action modules 1002-1008 are generated in accordance with the results from a project module (e.g., project module 406 described in FIG. 4). Action modules 1002-1008 may comprise any suitable combination or configuration of actions for a portfolio and/or a performance goal. For example, the action module 1002 for a pension plan comprises a contribution schedule. The contribution schedule may indicate action items that are associated with making contributions to the pension plan. The action module 1004 for the pension plan comprises investment policies. The investment policies may indicate policies associated with making investments such as scheduling a meeting with an investment advisor or reviewing an analysis of the pension plan with an advisor. The action module 1006 for the pension plan comprises risk transfers. The risk transfers may indicate action items for mitigating or shifting risks that are associated with the pension plan. The action module 1008 for the pension plan comprises plan designs. The plan designs may comprise action items associated with the design of the pension plan. Alternatively, any other suitable action modules may be employed as would be appreciated by one of ordinary skill in the art upon viewing this disclosure.

FIG. 11 is a flowchart of an embodiment of performance risk analysis method 1100. Method 1100 may be implemented by device such as server device 102 or user device 104 in FIG. 1, user device 202 in FIG. 2, or network element 300 in FIG. 3. In an embodiment, method 1100 may employed for a pension plan to obtain financial information, pension goals, and/or portfolios, to perform model simulations using the provided financial information and pension goals, and to determine performance metrics (e.g., likelihood of success) for meeting the pension goals based on the model simulation results. Further, method 1100 may be employed to determine a pension risk factor for the pension plan that indicates an amount of risk associated with the pension plan based on the provided financial information.

At step 1102, the device receives user information and a performance goal. For example, the user information may be financial information and the performance goal may be a pension performance goal. The device may receive the user information and performance goal via user and a user interface (e.g., user interface 114 in FIG. 1 or user interface 210 in FIG. 2) or a database (e.g., database 106 in FIG. 1 or database 204 in FIG. 2). In an embodiment, the device may receive a first portion of the user information from the user interface and a second portion of the user information from the database. At step 1104, the device generates a portfolio based on the user information and the performance goal. The device uses a scenario builder module (e.g., scenario builder module 404 in FIG. 4) to generate the portfolio based on the user information and the user goal. At step 1106, the device performs a stochastic simulation on the portfolio to generate a performance metric. The device uses a project module (e.g., project module 406 in FIG. 4) to perform stochastic simulations on the portfolio to generate a performance metric. For example, the device may use an ALM express to perform the stochastic simulation. In an embodiment, the device may output performance metrics for projected liabilities, contributions, plan expense, and/or assets. For example, the device may generate a likelihood of success performance metric or a pension risk factor such as the pension risk factor discussed in FIG. 8. At step 1108, the device outputs the performance metric. For example, the device may display the performance metric via the user interface, send the performance metric to a second device, or output a file, a graph, a table, a summary, a report, or any other suitable output as would be appreciated by one of ordinary skill in the art. The device may also be configured to store performance metrics into a memory.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A performance risk analysis method comprising:
receiving, at a device implemented in hardware, user information and a performance goal;
generating, at the device, a portfolio based on the user information and the performance goal;
performing, at the device, a stochastic simulation on the portfolio to generate a performance metric; and
outputting, from the device, the performance metric.

2. The method of claim 1, wherein the user information comprises financial information and wherein the performance goal is a pension performance goal.

3. The method of claim 1, wherein performing the stochastic simulation comprises using an asset/liability modeler (ALM) to generate the performance metric based on risks due to mismatches between assets and liabilities for the portfolio.

4. The method of claim 1, wherein the performance metric is a likelihood of success value.

5. The method of claim 1, wherein the performance metric is a pension risk factor, wherein the pension risk factor is
$$Pension Risk Factor = 1 - [ ( P B O Funded Ratio ) \times ( 1 - ( \frac{Risky Asset Exposure}{5} ) ) \times \sqrt{Hedge Ratio} ] ,$$
wherein project benefit obligation (PBO) funded ratio is the market value of assets divided by PBO liabilities, wherein risky asset exposure is the percentage of total invested in equities, and wherein hedge ratio is the estimated portion of liabilities that are protected from interest rate risk.

6. The method of claim 1, wherein outputting the performance metric comprises displaying the performance metric.

7. The method of claim 1, wherein outputting the performance metric comprises generating a summary that indicates at least one of a likelihood of success value and a pension risk factor.

8. The method of claim 1, wherein outputting the performance metric comprises sending the performance metric to at least one of a user device and a database.

9. The method of claim 1, further comprising determining, at the device, an action based on the performance metric.

10. The method of claim 1, wherein receiving the user information comprises receiving financial information for the user information from a database.

11. An apparatus comprising:
a receiver configured to receive user information and a performance goal;
a memory; and
a processor operably coupled to the receiver and the memory, and configured to:
generate a portfolio based on the user information and the performance goal;
perform a stochastic simulation on the portfolio to generate a performance metric; and
output the performance metric.

12. The apparatus of claim 11, wherein the user information comprises financial information and wherein the performance goal is a pension performance goal.

13. The apparatus of claim 11, wherein performing the stochastic simulation comprises using an asset/liability modeler (ALM) to generate the performance metric based on risks due to mismatches between assets and liabilities for the portfolio.

14. The apparatus of claim 11, wherein the performance metric is a likelihood of success value.

15. The apparatus of claim 11, wherein the performance metric is a pension risk factor, wherein the pension risk factor is
$$Pension Risk Factor = 1 - [ ( P B O Funded Ratio ) \times ( 1 - ( \frac{Risky Asset Exposure}{5} ) ) \times \sqrt{Hedge Ratio} ] ,$$
wherein project benefit obligation (PBO) funded ratio is the market value of assets divided by PBO liabilities, wherein risky asset exposure is the percentage of total invested in equities, and wherein hedge ratio is the estimated portion of liabilities that are protected from interest rate risk.

16. The apparatus of claim 11, wherein outputting the performance metric comprises displaying the performance metric.

17. The apparatus of claim 11, wherein outputting the performance metric comprises generating a summary that indicates at least one of a likelihood of success value and a pension risk factor.

18. The apparatus of claim 11, wherein outputting the performance metric comprises sending the performance metric to at least one of a user device and a database.

19. The apparatus of claim 11, further comprising determining, at the device, an action based on the performance metric.

20. The apparatus of claim 11, wherein receiving the user information comprises receiving financial information for the user information from a database.
